(19) United States
(12) Patent Application Publication
(10) Pub. No.: US 2017/0339525 A1
(43) Pub. Date: Nov. 23, 2017

(54) UUID Entity Update

(71) Applicants: Andrew Schrader, Raleigh, NC (US); Colby Greene, Raleigh, NC (US); Vamshi Guduguntla, Raleigh, NC (US)

(72) Inventors: Andrew Schrader, Raleigh, NC (US); Colby Greene, Raleigh, NC (US); Vamshi Guduguntla, Raleigh, NC (US)

(21) Appl. No.: 15/598,296

(22) Filed: May 17, 2017

Related U.S. Application Data
(60) Provisional application No. 62/337,569, filed on May 17, 2016.

(51) Int. Cl. H04W 4/02; H04L 29/08; H04W 8/18

(52) U.S. Cl. CPC H04W 4/028; H04W 8/18; H04L 67/18; H04L 67/22

(57) ABSTRACT

The Reveal™ mobile app installed and activated on an iOS mobile device may update the list of beacon UUIDs maintained in the iOS mobile device on an ad hoc basis. The update of the UUID list may be made to provide the iOS mobile device with a list of beacons that may be detected near their geographic location such that the user of the iOS mobile device may take advantage of recommendations for items or locations of interest located geographically near the iOS mobile device location. The Reveal™ application server and app work together to keep the beacon UUID list current so that recommendations to a user of the iOS mobile device may be equally current.

### CLAIM OF PRIORITY

This Non-Provisional application claims under 35 U.S.C. §120, the benefit of the Provisional Application 62/337,569, filed May 17, 2016, Titled “UUID Entity Update”, which is hereby incorporated by reference in its entirety.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

A beacon is one implementation of a proximity activation system that enables a smartphone or other Bluetooth-enabled device to perform actions when in close proximity to a beacon receiver/transmitter.

One application of a beacon is to help a smartphone determine its precise position or context. With the help of a signal from a beacon, a smartphone's software can pinpoint its approximate location in relation to other specified locations. A smartphone can store a list of the beacon “bumps” (specific instances of receiving a signal from a specific beacon) for software installed on the device to pull from in order to provide the user with information about specific products, offers, or technology associated with the beacon “bump”. Beacon technology works using the Bluetooth Low Energy (BLE) technology, also known as Bluetooth Smart.

Both iOS-based devices and non-iOS-based devices have software used to transmit and receive information from beacons. While non-iOS-based devices can store a large number of UUIDs in their histories, iOS-based devices can only store a maximum of 20 UUIDs at any given time. This limits the ability of software to predict the most likely beacons the smartphone will encounter in the future as well as limiting developers and purchasers of that software in attempts to predict trends and patterns of smartphone users and their travels. If software on iOS-based devices had the ability to pull predictive patterns of beacon encounters from a longer and more tested set of data, more accurate consumer profiles could be created and used to provide iOS-based device users with an enhanced mobile device experience.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a system diagram for an exemplary system operation consistent with certain embodiments of the present invention.

FIG. 2 is a system diagram for establishing a connection for the transfer of UUID information consistent with certain embodiments of the present invention.

FIG. 3 is a process flow for the geographic determination of a UUID list for an iOS mobile device consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings.

The terms “a” or “an”, as used herein, are defined as one, or more than one. The term “plurality,” as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to a beacon refers to a low energy Bluetooth (BLE) device operating as a proximity activation system that transmits packets of data that allow smart devices (such as phones, tablets, computers, handheld devices, game devices, etc.) to be informed when they are in range, and where smart devices are capable of calculating their proximity to the beacon.

Reference throughout this document to a Reveal™ mobile app refers to a software module executing on a mobile device. Reference throughout this document to a Reveal™ application server refers to a software module executing on an application server. Mobile applications do not utilize cookies and for this reason the website advertising model, which relies heavily upon cookie tracking, does not work for mobile advertising. In common practice, cookies track the locations a user visits across the web through the mechanism of placing a small tracking file, or cookies, within a user's computer system. These cookies are usable by the application or web page that placed it within the cookie folder on the user computer file system. In a non-limiting example, because cookies can't track digital locations in mobile devices, we can use physical location like latitude and longitude coordinates or activation by a proximity activation system as a replacement for the cookie mechanism recited herein to “cookie” where someone visits in the real world.

Utilizing location information gathered from a proximity activation system, such as a beacon, provides highly accurate location information for a mobile device that comes within range of the beacon's signal. In a non-limiting example, when a mobile device detects a beacon's signal, an application on the mobile device uses the Received Signal Strength Indication (RSSI), which is compared against a pre-set distance to signal strength ratio, to determine proximity to the beacon as well as the accuracy of its estimation of proximity. The stronger the signal, the more confident the mobile device can be about the proximity of the beacon. Refining the location of a mobile device may require a location determination system to increase location accuracy.

Beacon signals have largely been used in a real-time context to send a push alert or coupon to a mobile device or smartphone within range of the beacon. While this is a useful application, there is a great deal of information that can be learned about the owner of the mobile device interacting with the beacon that can be used for successful marketing campaigns at future points in time.

One of the greatest challenges in mobile advertising is getting an accurate sense for where people visit in the physical world. The event of a user passing within range of a beacon, so as to activate the beacon and create a “bump”, establishes a fixed point of reference for identifying with certainty that a mobile device was in a particular physical location at a specified time. Because most mobile devices are the property of a single individual, these beacon “bumps” assist in identifying and categorizing the habits and preferences of individuals while remaining an anonymous source of information. In an exemplary embodiment, the location determination system utilizes a multipoint trilateration calculation to significantly improve the determination of the physical location of the proximity activation system, such as a Beacon, with which the mobile device is interacting.

An additional consideration for iOS based devices is the issue that the device is configured to store and maintain a limited number of beacon identifiers. In current configurations, the limit is twenty beacon identifiers at any one time. This limitation presents an issue when attempting to review the beacon identifiers to predictively offer the user of the iOS mobile device one or more opportunities for discounts or locations of interest to the user. To overcome this limitation, the instant innovation presents an enhancement to the update process of the list of Universal User Identifiers (UUIDs) for beacons stored and maintained in the iOS mobile device.

In an exemplary embodiment, the Reveal™ mobile app is installed on an iOS mobile device. When an iOS mobile device thus enabled with the Reveal™ mobile app enters the communication field of a beacon and collects the identification information, including the beacon UUID, this information is transmitted to the Reveal™ application server. The Reveal™ application server may look up the beacon UUID information in an internal database to determine the physical location of the encountered beacon. To assist the iOS mobile device in providing information and opportunities to the iOS mobile device user, the Reveal™ application server may retrieve a set of nearby UUIDs from the system database that are associated with beacons that are all within a pre-determined range of the encountered beacon. This list of nearby UUIDs may be transmitted to the iOS mobile device with an instruction to replace the current set of beacon UUIDs with the set of nearby UUIDs transmitted from the Reveal™ application server. This replacement operation provides the user of the iOS mobile device with the beacon locations for shopping, locations of interest, and opportunities of interest to the user and provides for the predictive recommendation of these locations to the user on the iOS display.

In another exemplary embodiment, the Reveal™ mobile app is installed on an iOS mobile device. Once again, when the iOS mobile device enabled with the Reveal™ mobile app enters the communication field of a beacon the iOS mobile device collects the beacon information, including the beacon UUID associated with the encountered beacon. The beacon UUID associated with the encountered beacon is transmitted to the Reveal™ application server. With this identification, the Reveal™ application server may then build one or more classifications for the beacon at that specific location. In the non-limiting example where the beacon is identified as being installed in a café, the Reveal™ application server may map a café to a classification of Food&Drink>café, which then has the capability to personify any smart device that comes into contact with that classified beacon belonging to a coffee drinker. It should be noted that a beacon may have more than one classification identified with that beacon based upon inferences for the types of retail or other activity that is associated with the place type.

The Reveal™ application server may then determine one or more persona classifications that are appropriate for the iOS mobile device based upon the history of user for the iOS mobile device. The persona may be a collective history of beacon activatations associated with a particular iOS mobile device. As a non-limiting example, the persona may include details for each beacon activation, including beacon UUID, location, dates and times, classifications of the beacon, and other information associated with the beacon. The persona may be analyzed to determine patterns of movement and behavior that may reveal details about the users of the iOS mobile device. As a non-limiting example, a simple pattern analysis of the persona may reveal that user of the iOS mobile device is likely to stop at a specific coffee shop on most weekdays and that the user of the iOS mobile device usually stops at a woman's clothing store immediately after leaving the coffee shop. The Reveal™ application server may also retrieve a set of pre-determined UUIDs that are not only associated with the geographic area in which the beacon is located, but also are relevant to the one or more personas that the Reveal™ application server has identified for the iOS mobile device. As non-limiting examples, relevant UUIDs may include those UUIDs which the iOS mobile device has encountered previously and UUIDS that are associated in some way with previously captured tracking information, such as a UUID that has one or more of the same classifications as a previously encountered UUID. The Reveal™ application server may then send the one or more personas to the iOS mobile device as well as the list of up to twenty UUIDs for beacons located within a pre-determined geographic area that is calculated as having the iOS mobile device at the center of the geographic area. The Reveal™ mobile app instructs the iOS mobile device to replace the current UUID list with the transmitted list, and installs the one or more personas in the database associated with the Reveal™ mobile app on the iOS mobile device. The Reveal™ mobile app may then determine locations, shopping, or other opportunities that are of interest to the iOS mobile device user based upon the persona information and locations of the UUIDs within geographic range of the iOS mobile device. This information may be predicted to be of interest or use to the user of the iOS mobile device and be provided as recommendations on the display of the iOS mobile device.

The recommendations determined to be of interest to the user of the iOS mobile device by the Reveal™ mobile app may be based upon classifications for each identified beacon. The classifications may be classified as to the desired relevance, or value, of the persona to the location for purposes of delivering advertising or other information to the iOS mobile devices that are, or were recently, in range of the beacon. In a non-limiting example, a desirable relevance would be an iOS mobile device classified as having a history of purchasing goods or services an advertiser provides to buyers. It would be a waste of time to present an advertisement for fishing lures to iOS mobile devices that come within range of a beacon installed in a café, or an advertisement that was being transmitted on behalf of a shop that is in a different geographic location than the iOS mobile device. However, it could be highly effective to present a coupon for a special promotion on coffee drinks to mobile devices classified as coffee drinkers that have come within range of that same beacon and are co-located in a geographic sense. The Reveal™ application server may collect click information for all ads or other informational messages that are presented to iOS mobile devices. This information permits the Reveal™ application server to provide metrics on the click-through of such ads by mobile devices both outside and within range of the beacon. Click-through data, and other metric data, may be used in analyses to show the effectiveness of various types of ads and messages presented by beacons based upon their physical location and location type, providing a new range of analytic information for iOS mobile devices that are within range of the identified beacon.

Attributing a mobile advertising spend to in-store foot traffic is impossible without highly accurate physical location data for a mobile device. Beacon recognition can address the need for creating highly accurate physical location identification of mobile devices. The Reveal™ application server may create a global database of precise beacon locations, which enables two distinct forms of highly targeted advertising capabilities. With a highly accurate physical location for each iOS mobile device, mobile advertising can be directed to particular mobile devices within proximity of a beacon that is most readily associated with the focus of the mobile ad after first transmitting to the iOS mobile device a set of up to 20 UUIDs that are relevant to the iOS mobile device geographically. The Reveal™ application server can provide highly accurate feedback on ads and information delivered a result of proximity to a particular beacon by tracking click through data from all iOS mobile devices in range of the beacon. Additionally, the personified mobile devices may be used to build mobile audience categories that a publisher can leverage to sell targeted ads that garner high clicks-per-minute (CPMs).

In an embodiment, demographic information may be combined with collected data from smart mobile devices. This information may include gender, income range, education level, age range, and additional demographic information available from public sources. The public sources consulted may include, but are not limited to, US Bureau of the Census, automotive data, TV viewing data, purchase data, and grocery store shopping data. The demographic data may provide the creation of new personas or may strengthen existing personas, enhancing the targeting and placement of advertising and informational messages and communications.

In a non-limiting example, when the iOS mobile device moves along a path of beacons that are associated with shopping (mall stores, grocery stores, drug stores, etc.) in the geographic area in which the iOS mobile device is located, the Reveal™ application server may be able to identify and associate a persona of a working mother with the mobile device. With this persona identification, the Reveal™ application server may look forward to one or more beacons installed in shopping locations that would be likely to be visited by a working mother and transmit a signal to the shopping location associated with the shopping location. The signal may present an opportunity for the shopping location to prospectively authorize a message, ad, or other signal to the mobile device when that mobile device activates the expected beacon. In this manner, predictive message placement may take place on a pre-determined, real time basis, or in an ad hoc manner to take advantage of the mobile device entering the shopping establishment.

In this non-limiting example, the Reveal™ application server may be able to provide, for a small fee or other consideration, some information on household size for that persona on that mobile device. Additionally, the Reveal™ application server may be able to provide predictive information on the likely purchases at any particular shopping location to permit the generation of “instant savings” coupons, special deal ads, or informational messages tailored for the persona on that mobile device. The shopping location contacted may instead choose to opt out of transmitting any information to the persona located on the mobile device unless a trigger event has occurred. Trigger events are those events that are established by a shopping location to set the conditions that must exist to permit the Reveal™ application server to issue coupons, ads, informational messages, or other signals to one or more personas located on the mobile device.

Predicting the path a mobile device may follow is not relegated to a single persona on a mobile device. Because multiple personas may be defined for a single mobile device, a predicted path for each of the personas associated with the mobile device may be prepared by the Reveal™ application server. The Reveal™ application server may then present a coupon, ad, informational message, or other signal to any persona in a mobile device regardless of the path the mobile device moves along. Predicting numerous paths presents multiple opportunities to prepare and transmit information to a mobile device regardless of the next step in the path being traveled and based upon the personas defined for the mobile device.

In an embodiment, the Reveal™ application server may build and expand upon data collected about a current set of UUIDs installed within an iOS mobile device reported to the Reveal™ application server. This creation and/or update of information may be stored within a database controlled and managed by the Reveal™ application server. Information to be collected and stored may include data about time of day the beacon was encountered, date, beacon UUID, additional beacon data, and any data about current personas installed on the iOS mobile device. It should be mentioned that the UUID location information may be verified by information from the same beacon UUID collected by Android devices and transmitted to the Reveal™ application server.

In an embodiment, the Reveal™ application server may evaluate latitude and longitude data provided by a GPS process associated with each iOS mobile device on which a Reveal™ enabled application is installed. Although the Reveal™ mobile app may not be active in the foreground of the iOS mobile device, the Reveal™ mobile app may continue to collect data and transmit the collected data to the Reveal™ application server upon activation of the Reveal™ mobile app. This data is provided upon the startup of the Reveal™ mobile app. The data may be analyzed and utilized to build known locations, such as home, work, and other locations for the mobile device, and additional persona information based upon location history. This information will be stored upon and managed by one or more Reveal™ application servers.

In an additional embodiment, a Reveal™ application server may utilize metrics and other collected data to evaluate all known locations, personas, and historical behaviors to create analytics for all mobile devices known to the system, including the iOS mobile device for which UUID updates are intended. This analytic information may be used to create predictive advertising for the iOS mobile devices. In this process, advertising data may be targeted for delivery to one or more iOS mobile device based upon predictions of future intent for each iOS mobile device and personas associated with the iOS mobile devices.

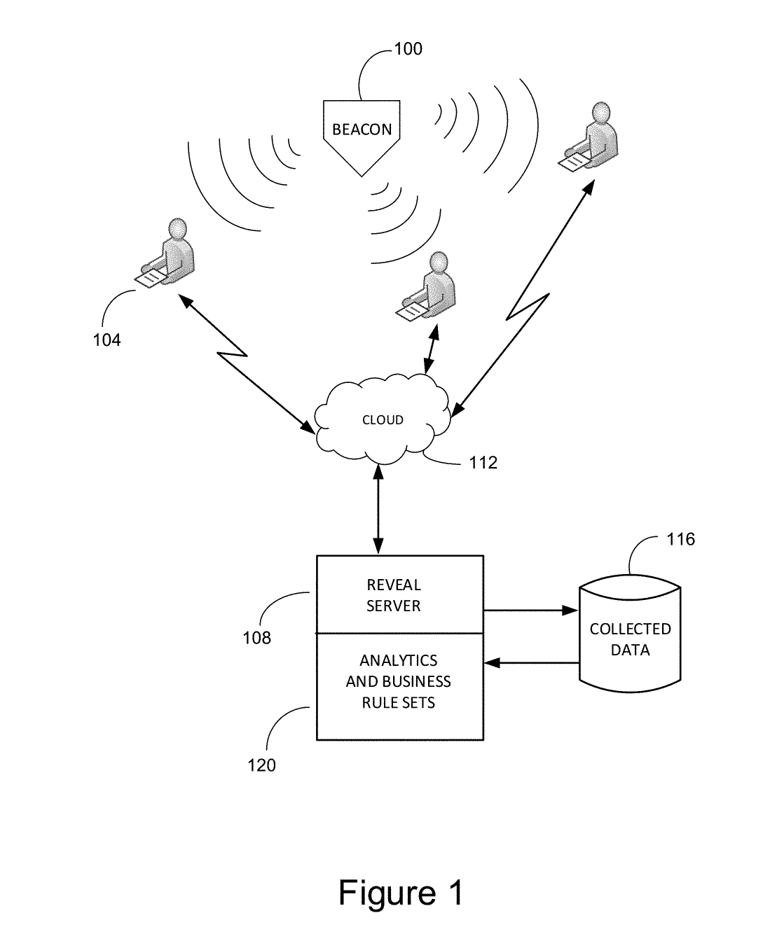

Turning now to FIG. 1, this figure presents a system diagram for an exemplary system configuration consistent with certain embodiments of the present invention. A proximity activation system 100 may be installed within physical locations such as stores, sporting areas, malls, parks, cafes and restaurants, or any other physical location where information may be transmitted to a mobile device 104. As a non-limiting example, the proximity activation system 100 may be a beacon. A beacon bump is an activation indication from the proximity activation system 100 that is transmitted to the Reveal™ application server 108 when a mobile device upon which the Reveal™ SDK has been installed. When a beacon bump is detected, the beacon information, containing at least the UUID, major, minor, and name fields, is transmitted to the Reveal™ application server 108 through one or more cloud servers 112. The Reveal™ application server 108 stores the transmitted beacon information in a place identification database 116 containing all of the collected data from all mobile devices, either as a new entry into a beacon data table or as an update to an entry already stored in the beacon data table. The Reveal™ application server 108 also adds geographical data, the latitude and longitude, for the beacon into a data table. Additionally data regarding the mobile device manufacturer, operating system type and other metrics are stored in a separate data table on the Reveal™ application server 108.

After the Reveal™ application server 108 has completed a refinement calculation for the geographical location of the proximity activation system 100, the Reveal™ application server 108 may seek to identify the location in which the proximity activation system 100 has been installed. In a non-limiting example, the Reveal™ application server 108 may contact a place identification database 116, such as Google Places, through the API and present the physical location information to check the type of place in which the proximity activation system 100 is operating. Once the type of place is returned from the places identification API, this information is stored in the place identification database 116 and associated with that particular beacon.

The Reveal™ application server 108 may also contain one or more sets of analysis and business rule sets 120 to determine a gender assignment that should be identified with a user or owner of each mobile device that reports a bump with a particular proximity activation system 100.

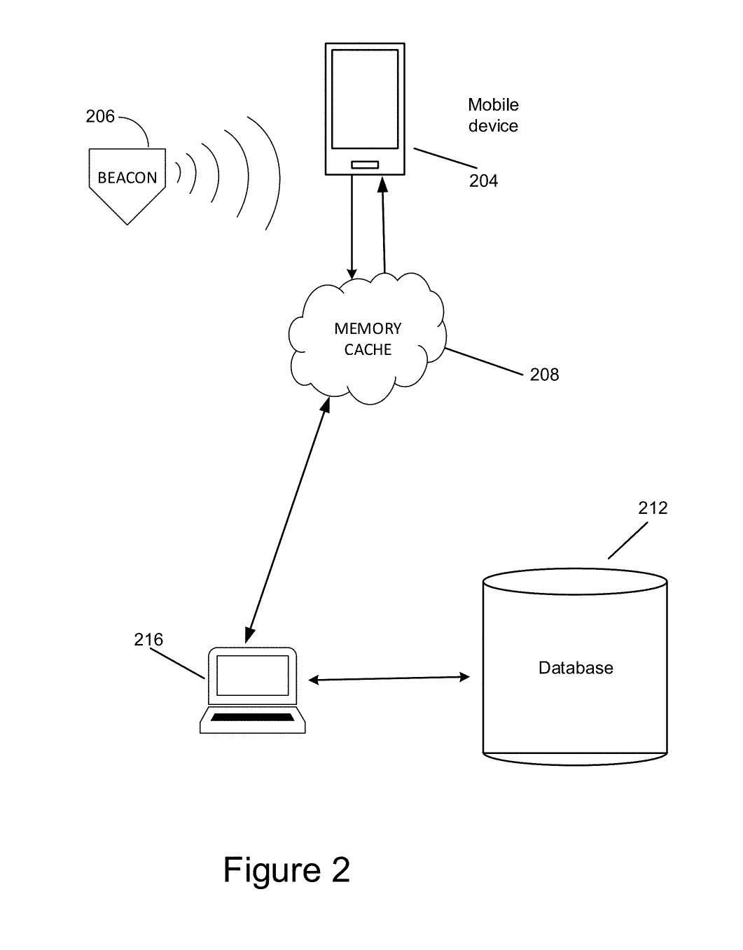

Turning to FIG. 2, this figure presents a system diagram for loading a set of UUIDs onto an iOS mobile device consistent with certain embodiments of the present invention. The iOS mobile device 204 detects the signal from a beacon 206 in a given location. If the Reveal™ mobile app is active, it may transmit the information from the beacon 206, including the UUID from the beacon 206, to the memory cache 208 associated with the Reveal™ application server 216. The geographic location of the beacon 206 is determined by the Reveal™ application server. The beacon 206 information is then analyzed to determine a set of UUIDs that are closest to the geographic location for the detected beacon 206. The UUIDs that are relevant to the detected beacon 206 may be within a pre-determined radius of the geographic location of the detected beacon 206. A set of up to 20 beacon UUIDs are retrieved from the database 212 associated with the Reveal™ application server 216.

The Reveal™ application server 216 may then transmit the collected set of UUIDs to the iOS mobile device 204. The Reveal™ mobile app may receive the collected set of UUIDs and install them within the UUID memory location within the iOS mobile device 204. The Reveal™ mobile app will then be able to provide recommendations to the user of the iOS mobile device for locations, shops, or other areas of interest that are geographically close to the location of the iOS mobile device 204.

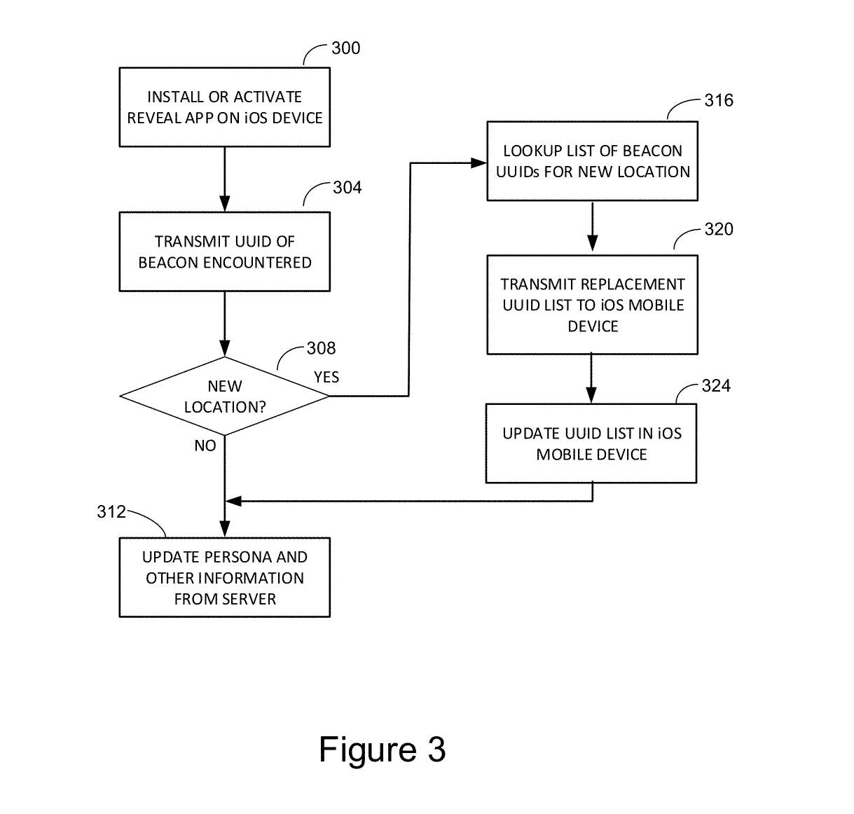

Turning to FIG. 3, this figure presents a process flow for the geographic determination of a UUID list for an iOS mobile device consistent with certain embodiments of the present invention. In an exemplary embodiment, a user may download and install the Reveal™ mobile app for an iOS mobile device, or, if the app is already installed, may activate the Reveal™ mobile app on the iOS mobile device at 300. When an iOS mobile device having the Reveal™ mobile app installed encounters a beacon signal, at 304 the beacon signal is captured and the UUID of the beacon is transmitted to the Reveal™ application server. If the iOS mobile device is geographically in or near the physical location mapped when an encounter immediately previous to the current beacon encounter, at 312 the Reveal™ application server may transmit updated persona and other relevant information to the Reveal™ mobile app from the Reveal™ application server.

If, however, the beacon encountered is located in a different geographic location from an encounter immediately previous to the current encounter, at 316 the Reveal™ application server may be activated to look up a list of beacon UUIDs that are geographically within a pre-determined distance from the current location of the iOS mobile device. This list of UUIDs may be selected to assist the Reveal™ mobile app in providing recommendations to the user of the iOS mobile device for locations or items of interest in or near the current location of the iOS mobile device as determined by the beacon activation and UUID. At 320, the Reveal™ application server may transmit the selected list of UUIDs, where the list may include any number of UUIDs up to twenty, to the Reveal™ mobile app installed within the iOS mobile device. At 324, upon receipt of the UUID list, the Reveal™ mobile app may update the UUID list within the iOS mobile device, and use this updated list for determining and displaying recommendations to the user of the iOS mobile device. The Reveal™ application server may also update persona and other information transmitted to the Reveal™ mobile app concurrently with the UUID list.

While certain illustrative embodiments have been described, it is evident that many alternatives, modifications, permutations, and variations will become apparent to those skilled in the art in light of the foregoing description.

We claim:

1. A system for recommending one or more destinations proximal to a mobile device comprising:
the mobile device,
a proximity activation system,
an application server,
a place identification database, and
a software module operative to determine a physical location of the proximity activation system by looking up the UUID in the place identification database, determine a set of nearby UUIDs corresponding to other proximity activation systems that are within a pre-determined range of the proximity activation system, and replace a current set of UUIDs stored on the mobile device with the set of nearby UUIDs corresponding to other proximity activation systems that are within a pre-determined range;
where the mobile device encounters the proximity activation system and collects identification information comprising a UUID (Universally Unique ID) from the proximity activation system;
a software module operative to recommend destinations to a user of the mobile device.

2. The system of claim 1,
where the application server stores at least a date, time, and the UUID in a history log associated with the mobile device.

3. The system of claim 2,
where the software module associates the mobile device with one or more classifications for the mobile device based upon one or more predetermined classifications of the proximity activation system.

4. The system of claim 3,
where the software module determines one or more personas associated with the mobile device by analyzing the tracking log associated with the mobile device;
where the one or more personas are stored in a database maintained by the application server.

5. The system of claim 4,
where the one or more personas associated with the mobile device are used by the mobile device to recommend destinations that are points of interest for the user.

6. The system of claim 5,
where the software module determines a set of UUIDs that are relevant to the one or more personas that the software module has identified for the mobile device.

7. A method for recommending one or more destinations proximal to a mobile device comprising:
encountering a proximity activation system and collecting identification information comprising a UUID (Universally Unique ID) from the proximity activation system;
determining a physical location of the proximity activation system by looking up the beacon UUID in a place identification database;
determining a set of nearby UUIDs associated with proximity activation systems that are within a pre-determined range;
replacing a current set of UUIDs stored on the mobile device with the set of nearby UUIDs obtained from the application server;
activating destination recommendations to the user of the mobile device.

8. The method of claim 7 further comprising, storing at least a date, a time, and the UUID in a tracking log associated with the mobile device.

9. The method of claim 8 further comprising,
determining one or more classifications of the mobile device based upon one or more pre-determined classifications of the specific location of the proximity activation system;
where the one or more classifications of the mobile device are stored in a database maintained by the application server.

10. The method of claim 9 further comprising
determining one or more personas associated with the mobile device based upon an analysis of a tracking log associated with the mobile device.

11. The method of claim 10, further comprising
transmitting the one or more personas associated with the mobile device to the mobile device;
where the one or more personas associated with the mobile device are used by the mobile device to recommend destinations that are points of interest for the user.

12. The method of claim 11,
where the step of determining a set of UUIDs associated with proximity activation systems that are within a pre-determined range of the proximity activation system further comprises sending UUIDs that are relevant to the one or more personas that the application server has identified for the mobile device.
